(19) United States
(12) Patent Application Publication
(10) Pub. No.: US 2024/0036544 A1
(43) Pub. Date: Feb. 1, 2024

(54) CONTROL DEVICE, SAFE STOP PROGRAM THEREFOR, AND STORAGE MEDIUM

(71) Applicant: Fanuc Corporation, Minamitsuru-gun, Yamanashi (JP)

(72) Inventor: Hideo Kobayashi, Minamitsuru-gun, Yamanashi (JP)

(73) Assignee: Fanuc Corporation, Minamitsuru-gun, Yamanashi (JP)

(21) Appl. No.: 18/265,283

(22) PCT Filed: Dec. 20, 2021
(86) PCT No.: PCT/JP2021/046974

§ 371 Date: Jun. 5, 2023

(30) Foreign Application Priority Data
Dec. 23, 2020 (JP) 2020-213229

(51) Int. Cl. G05B 19/406

(52) U.S. Cl. CPC G05B 19/406; G05B 2219/50193

(57) ABSTRACT

A control device according to the present invention includes a main control unit configured to control a main operation of a controlled object, a sub-control unit configured to control an operation of an attached device of the controlled object, and a sequence program execution unit configured to transmit and receive a command between the main control unit and the sub-control unit, the sequence program execution unit has a function of transmitting a stop command signal SD to the sub-control unit when receiving a power stop signal PD from outside of the control device, and then transmitting a power stop command signal SP to a power supply unit when receiving a stop confirmation signal SE from the sub-control unit.

### CROSS REFERENCE TO RELATED APPLICATIONS

This is the U.S. National Phase application of PCT/JP2021/046974, filed Dec. 20, 2021, which claims priority to Japanese Patent Application No. 2020-213229, filed Dec. 23, 2020, the disclosures of each of these applications being incorporated herein by reference in their entireties for all purposes.

### FIELD OF THE INVENTION

The present invention relates to a safety stop technique related to a control device including a main control unit that controls a main operation of a machine, a sub-control unit that controls an operation of an attached device of the machine, and a sequence program execution unit that transmits and receives a command to and from the main control unit and the sub-control unit.

### BACKGROUND OF THE INVENTION

For example, in a control device that automatically controls a controlled object such as a machine tool, a configuration including a numerical control unit that controls the controlled object based on a machining program, an operation panel to which an operator can input various conditions and the like, and a controller unit that is connected to the numerical control unit and the operation panel and transmits a command inside and outside the control device is known. As a control device having such a configuration, Patent Literature 1 discloses an NC machine tool management system including: an NC machine tool including a component machining unit configured to perform component machining by numerical control, a numerical control unit configured to control an operation of the component machining unit according to a predetermined machining program, an operation panel unit configured for inputting an instruction from an operator, and a controller unit configured to control signal transmission between the component machining unit, the numerical control unit, and the operation panel unit and be connectable to a network; a remote operation unit configured for remotely operating the NC machine tool via the network; and a network for transmitting a signal between the NC machine tool and the remote operation unit.

### PATENT LITERATURE

### Patent Literature 1: JP 2000-315103 A

### SUMMARY OF THE INVENTION

Incidentally, a control unit such as a computer that controls the operation of these components is usually mounted on the numerical control unit and the operation panel as exemplified above. Power is supplied from an external power supply unit to such a control unit, and the operation is controlled by software or the like stored in an internal memory.

However, when these control units stop power supply without terminating the operation (a so-called shutdown) with an appropriate procedure, necessary information such as software stored in the memory may be destroyed. Therefore, in order to avoid power stop without normally shutting down the control unit of the control device, it is necessary to use an additional configuration such as providing a shutdown unit or an uninterruptible power supply (UPS) in addition to the control device.

From such circumstances, there is a demand for a control device and a safe stop program capable of safely executing a stop operation of the control device without providing an additional configuration other than the control device.

According to one aspect of the present invention, a control device including a main control unit configured to control a main operation of a machine, a sub-control unit configured to control an operation of an attached device of the machine, and a sequence program execution unit configured to transmit and receive a command between the main control unit and the sub-control unit, has a function in which the sequence program execution unit transmits a stop command signal to the sub-control unit when receiving a power stop signal from outside, and transmits a power stop command signal to a power supply unit when receiving a stop confirmation signal from the sub-control unit thereafter.

Furthermore, according to another aspect of the present invention, a safe stop program for causing a sequence program execution unit of a control device including a main control unit configured to control a main operation of a machine, a sub-control unit configured to control an operation of an attached device of the machine, and a sequence program execution unit configured to transmit and receive the command to and from the main control unit and the sub-control unit to execute a series of safe stop operations described below, is configured to execute a step of receiving a power stop signal from outside, a step of transmitting a stop command signal to the sub-control unit, a step of receiving a stop confirmation signal from the sub-control unit, and a step of transmitting a power stop command signal to the power supply unit.

Furthermore, according to still another aspect of the present invention, a storage medium storing a safe stop program for causing a sequence program execution unit of a control device including a main control unit configured to control a main operation of a machine, a sub-control unit configured to control an operation of an attached device of the machine, and a sequence program execution unit configured to transmit and receive a command between the main control unit and the sub-control unit to execute a series of safety stop operations described below, is configured such that the safe stop program executes a step of receiving a power stop signal from outside, a step of transmitting a stop command signal to the sub-control unit, a step of receiving a stop confirmation signal from the sub-control unit, and a step of transmitting a power stop command signal to the power supply unit.

According to each of the aspects of the present invention described above, the sequence program execution unit of the control device has a function of transmitting the stop command signal to the sub-control unit when receiving the power stop signal from outside of the control device, and transmitting a power stop command signal to the power supply unit when receiving the stop confirmation signal from the sub-control unit thereafter. Therefore, it is possible to safely execute a stop operation of the control device without providing an additional configuration other than the control device.

### BRIEF DESCRIPTION OF DRAWINGS

FIG. 1 is a block diagram illustrating a relationship between a control device and a target device according to a first embodiment of the present invention.

FIG. 2 is a time chart illustrating a specific example of a safe stop operation by a safe stop program executed by a sequence program execution unit of the control device according to the first embodiment of the present invention.

FIG. 3 is a time chart illustrating a specific example of a safe stop operation based on a safe stop program executed by a sequence program execution unit of a control device according to a modification of the first embodiment of the present invention.

FIG. 4 is a block diagram illustrating a relationship between a control device and a peripheral device connected thereto according to a second embodiment of the present invention.

FIG. 5 is a time chart illustrating a specific example of a safe stop operation based on a safe stop program executed by a sequence program execution unit of the control device according to the second embodiment of the present invention.

FIG. 6 is a block diagram illustrating a relationship between a control device and a peripheral device connected thereto according to a third embodiment of the present invention.

### DETAILED DESCRIPTION OF EMBODIMENTS OF THE INVENTION

Hereinafter, embodiments of a control device such as a machine tool according to a representative example of the present invention will be described with reference to the drawings.

### First Embodiment

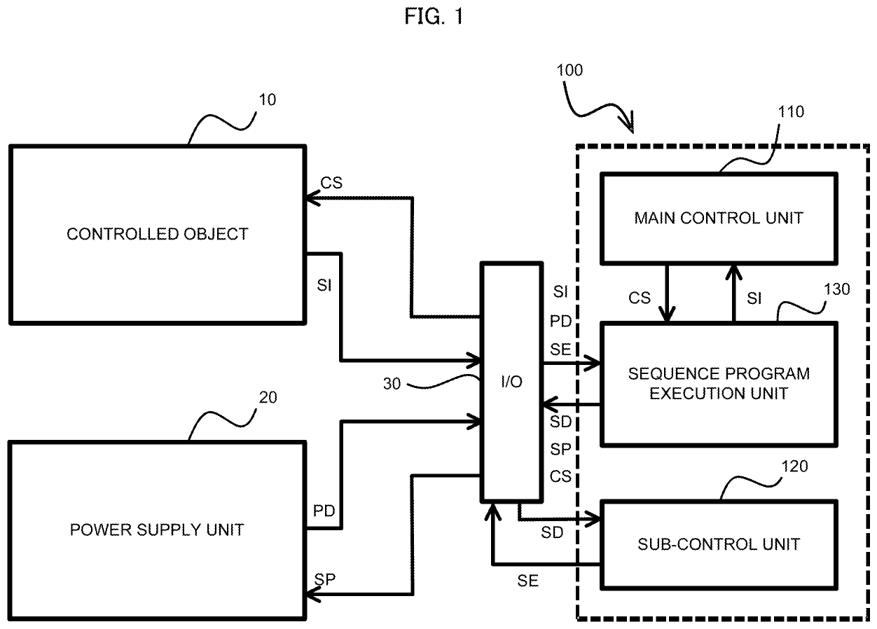

FIG. 1 is a block diagram illustrating a relationship between a control device according to a first embodiment and a peripheral device connected thereto, which is a representative example of the present invention. As illustrated in FIG. 1, a control device 100 according to the first embodiment is connected to a controlled object 10 such as a machine tool and a power supply unit 20 that supplies power to the control device 100 in a wired or wireless manner so as to be able to exchange signals with each other.

As described above, the controlled object 10 is configured as a device that can be automatically controlled by the control device 100 of the present invention, such as a machine tool, a conveyance machine, or a robot, and is connected to a sequence program execution unit 130 via an I/O unit 30 in addition to a control line (not illustrated) of the control device 100. As one example, the controlled object 10 has a function of receiving a control command CS from a main control unit 110 and executing the instructed operation to the peripheral device, and a function of transmitting various parameters related to the state of the peripheral device of the controlled object 10 to the main control unit 110 as state information SI.

As one example, the power supply unit 20 is a mechanism that supplies power for driving the controlled object 10 and the control device 100, and is connected to the control device 100 through a signal line via the I/O unit 30 in addition to a power line (not illustrated). Furthermore, the power supply unit 20 includes an input mechanism (for example, a button or the like, is not illustrated) for a user to instruct to stop the power supply when the operation of the controlled object 10 or the control device 100 is finished, and transmits a power stop signal PD to the control device 100 and receives a power stop command signal SP from the control device 100 to execute a power stop processing.

The I/O unit 30 is connected to the sequence program execution unit 130 of the control device 100, and is configured as a mechanism that exchanges input and output of various signals (for example, the control command CS, the power stop command signal SP, and the like) with the peripheral devices (the controlled object 10 and the power supply unit 20) outside the control device 100. Furthermore, the I/O unit 30 is also connected to a sub-control unit 120 of the control device 100, and exchanges the input and output of a stop command signal SD and a stop confirmation signal SE with the sequence program execution unit 130. With these configurations, a safe power stop processing is realized without using an additional configuration.

As one example, the control device 100 according to the first embodiment includes the main control unit 110 configured to control a main operation of the controlled object 10, the sub-control unit 120 configured to control an operation of an attached device (for example, a display device or the like) of the controlled object 10, and the sequence program execution unit 130 configured to transmit and receive a command signal to and from the main control unit 110 and the sub-control unit 120.

The main control unit 110 is configured to automatically control the operation of the device of the controlled object 10, and may be, for example, a numerical controller (CNC) that issues a control command based on a machining program. As one example, the main control unit 110 generates the control command CS for the controlled object 10 based on the machining program, and performs a motor control via a control line (not illustrated). Furthermore, the main control unit 110 transmits the control command CS of the peripheral device of the controlled object 10 from the sequence program execution unit 130 to be described later to the controlled object 10 via the I/O unit 30.

As described above, the sub-control unit 120 controls the operation of the attached device of the controlled object 10 such as a display device or a user interface (not illustrated). Furthermore, the sub-control unit 120 transfers data such as display data and a program to the main control unit 110 via a data line (not illustrated). Further, the sub-control unit 120 stores a control program (OS), an operation parameter, and the like for this purpose in a memory (not illustrated), and controls the operation of the attached device based on the control program. The sub-control unit 120 having such a configuration is required to safely stop the power supply in order to hold information such as the control program and the operation parameter stored in the memory.

The sequence program execution unit 130 is a control unit having a function as a relay circuit between the main control unit 110 and an external device, and as one example thereof, a programmable controller (PLC) can be exemplified. Further, based on the safe stop program, the sequence program execution unit 130 exchanges transmission and reception of the control command CS and the state information SI to and from the controlled object 10 with respect to the main control unit 110, and exchanges the stop command signal SD and the stop confirmation signal SE for performing the safe power stop processing of the sub-control unit 120 with respect to the sub-control unit 120. Furthermore, the sequence program execution unit 130 exchanges the power stop signal PD and the power stop command signal SP with the power supply unit 20.

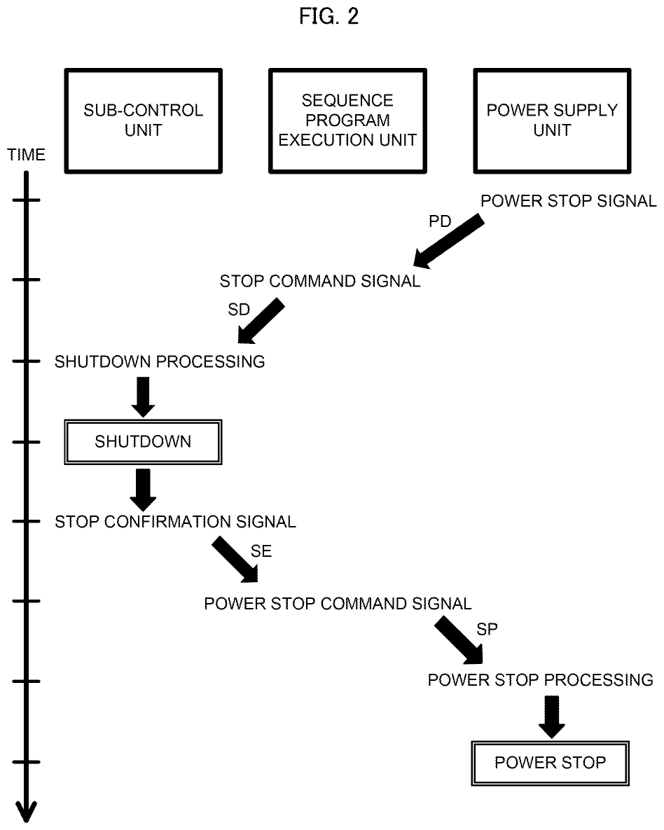

FIG. 2 is a time chart illustrating a specific example of the safe stop operation based on the safe stop program executed by the sequence program execution unit of the control device according to the first embodiment of the present invention. In addition, in the time chart illustrated in FIG. 2, it is assumed that time passes from top to bottom in the drawing with a vertical axis as time.

As illustrated in FIG. 2, the safe stop program according to the first embodiment is executed when the power stop signal PD is issued in the power supply unit 20 (a step of receiving the power stop signal PD from the power supply unit 20). In addition, as described above, the power stop signal PD may be generated not only by the input from the input mechanism of the power supply unit 20, but also, for example, when the power supply unit 20 is urgently stopped or when an abnormality occurs in the power supply unit 20.

When receiving the power stop signal PD, the sequence program execution unit 130 issues the stop command signal SD to the sub-control unit 120 (a step of transmitting a stop command signal to the sub-control unit 120). Further, the sub-control unit 120 that has received the stop command signal SD performs an operation end processing (a shutdown processing).

When the operation end processing is normally ended, the sub-control unit 120 issues the stop confirmation signal SE to the sequence program execution unit 130. Further, when receiving the stop confirmation signal SE from the sub-control unit 120 (a step of receiving the stop confirmation signal SE from the sub-control unit 120), the sequence program execution unit 130 issues the power stop command signal SP to the power supply unit 20 (a step of transmitting the power stop command signal SP to the power supply unit 20).

Next, when receiving the power stop command signal SP from the sequence program execution unit 130, the power supply unit 20 executes the power stop processing. Accordingly, the stop of the operation of the control device 100 is safely executed after confirming the end of the operation of the sub-control unit 120.

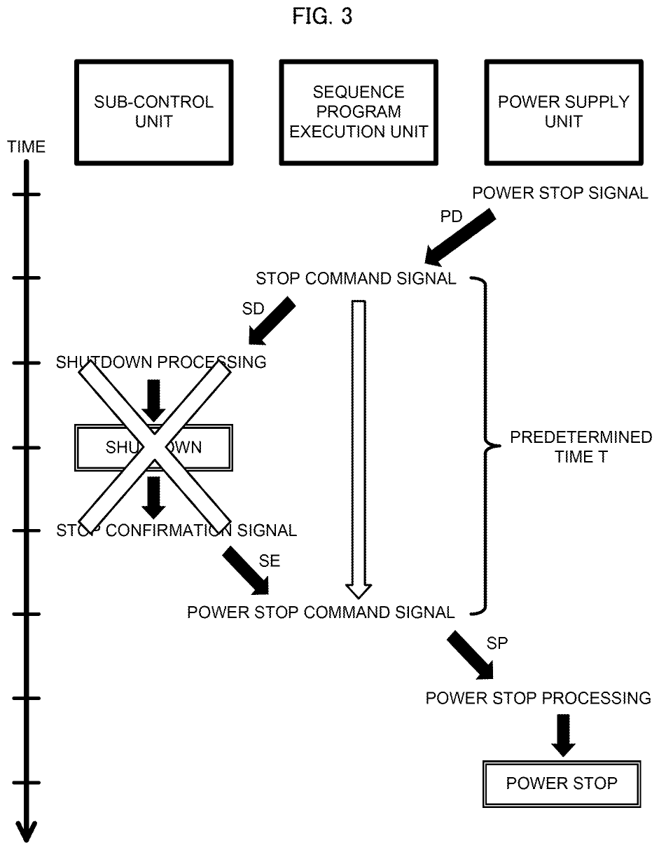

FIG. 3 is a time chart illustrating a specific example of the safe stop operation based on the safe stop program executed by the sequence program execution unit of the control device according to the modification of the first embodiment of the present invention. In addition, also in the time chart illustrated in FIG. 3, it is assumed that time passes from top to bottom in the drawing with the vertical axis as time.

In the modification of the first embodiment illustrated in FIG. 3, when receiving the power stop signal PD from the power supply unit 20, the sequence program execution unit 130 issues the stop command signal SD to the sub-control unit 120. Then, as in the time chart illustrated in FIG. 2, normally, the sub-control unit 120 that has received the stop command signal SD executes the operation end processing (the shutdown processing).

However, when the sub-control unit 120 does not normally receive the stop command signal SD from the sequence program execution unit 130, or when the sub-control unit 120 does not normally end the operation end processing, the sub-control unit 120 does not transmit the stop confirmation signal SE to the sequence program execution unit 130. In such case, since the sequence program execution unit 130 cannot confirm reception of the stop confirmation signal SE from the sub-control unit 120, the sequence program execution unit 130 does not transmit the power stop command signal SP.

Therefore, as illustrated in FIG. 3, when the sequence program execution unit 130 does not receive the stop confirmation signal SE even after a predetermined time T elapses after transmitting the stop command signal SD, the sequence program execution unit 130 forcibly transmits the power stop command signal SP (without waiting for the reception of the stop confirmation signal SE from the sub-control unit 120). Accordingly, the power stop processing can be performed only with the configuration of the control device 100. Furthermore, instead of forcibly transmitting the power stop command signal SP, the sequence program execution unit 130 may be configured to transmit the power stop command signal SP while storing the fact that the stop confirmation signal SE has not been received as a history of alarms.

In addition, the safe stop program executed by the sequence program execution unit 130 described above can be stored in various storage media such as a CD-ROM, a hard disk, or a mass storage device. Accordingly, the safe stop program according to the present invention can be executed on a plurality of different control devices 100, and the safe stop program can be copied and used.

With the above configuration provided, in the control device and the safe stop program according to the first embodiment, the sequence program execution unit of the control device has a function of transmitting the stop command signal to the sub-control unit when receiving the power stop signal from the power supply unit, and then transmitting the power stop command signal to the power supply unit when receiving the stop confirmation signal from the sub-control unit, so that it is possible to safely execute the stop operation of the control device without providing an additional configuration other than the control device.

### Second Embodiment

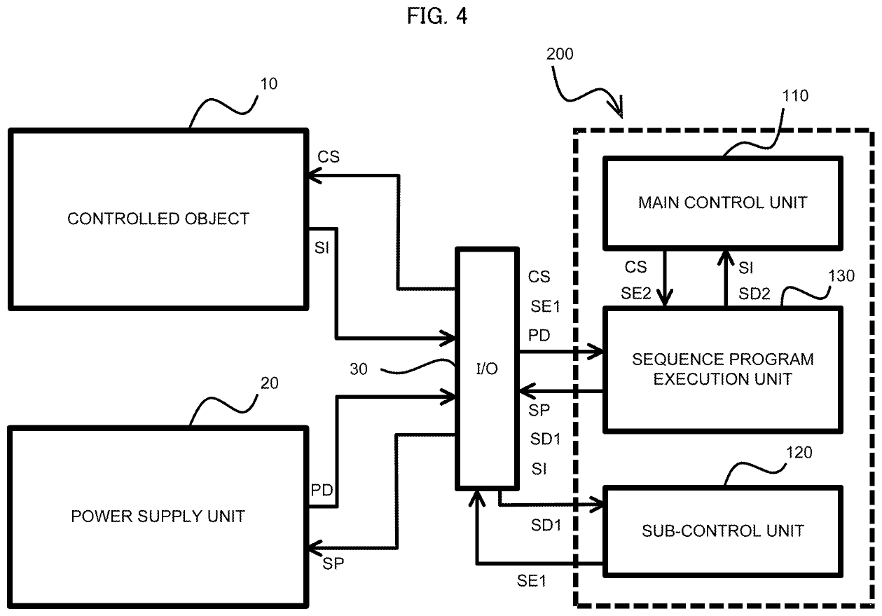

FIG. 4 is a block diagram illustrating a relationship between a control device according to a second embodiment of the present invention and a peripheral device connected to the control device. In addition, in the second embodiment, components that can adopt the same or common configurations as those of the control device of the first embodiment illustrated in FIG. 1 are denoted by the same reference numerals, and repeated description thereof is omitted.

In the control device 200 according to the second embodiment, the safe stop program executed by the sequence program execution unit 130 is configured to instruct the main control unit 110 to perform the operation end processing, for example, when the main control unit 110 needs to safely stop when the power is turned off, similarly to the sub-control unit 120. In other words, as illustrated in FIG. 4, in addition to the functions according to the first embodiment, the sequence program execution unit 130 further has a function of transmitting a stop command signal SD2 to the main control unit 110 when receiving the power stop signal PD from the power supply unit 20 based on the safe stop program, and then transmitting a power stop command signal SP to the power supply unit 20 when receiving a stop confirmation signal SE2 from the main control unit 110.

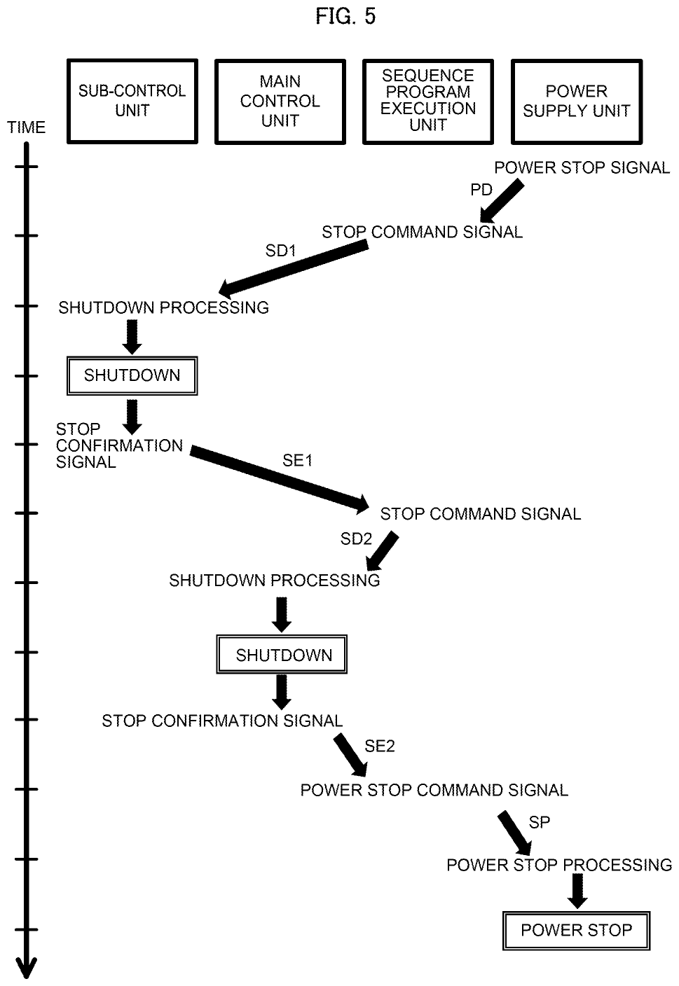

FIG. 5 is a time chart illustrating a specific example of the safe stop operation based on the safe stop program executed by the sequence program execution unit of the control device according to the second embodiment of the present invention. In addition, also in the time chart illustrated in FIG. 5, it is assumed that time passes from top to bottom in the drawing with the vertical axis as time.

As illustrated in FIG. 5, the safe stop program is executed when the power stop signal PD is issued in the power supply unit 20. Subsequently, when receiving the power stop signal PD, the sequence program execution unit 130 issues a stop command signal SD1 to the sub-control unit 120. Further, the sub-control unit 120 that has received the stop command signal SD1 performs the operation end processing (the shutdown processing), and when the operation end processing is normally ended, a stop confirmation signal SE1 is issued to the sequence program execution unit 130.

Next, when receiving the stop confirmation signal SE1 from the sub-control unit 120, the sequence program execution unit 130 issues the stop command signal SD2 to the main control unit 110. Then, the main control unit 110 that has received the stop command signal SD2 performs the operation end processing (the shutdown processing), and when the operation end processing is normally ended, a stop confirmation signal SE2 is issued to the sequence program execution unit 130.

When receiving the stop confirmation signal SE2, the sequence program execution unit 130 issues the power stop command signal SP to the power supply unit 20. The power supply unit 20 that has received the power stop command signal SP executes a power stop processing. Accordingly, the stop of the operation of the control device 200 is safely executed after confirming the end of the operation of the sub-control unit 120.

With the above configuration provided, the control device and the safe stop program according to the second embodiment of the present invention can perform the power stop processing after confirming the end of the operation of the main control unit 110 while protecting the software, parameters, and the like stored in the main control unit 110, in addition to the effects described in the first embodiment.

In addition, in FIG. 5, the operation in which the sequence program execution unit 130 instructs and confirms the operation end processing with respect to the main control unit 110 after instructing and confirming the operation end processing with respect to the sub-control unit 120 has been exemplified. However, the sequence program execution unit 130 may be configured to simultaneously execute the instruction of the operation end processing with respect to the main control unit 110 and the sub-control unit 120 in parallel. Accordingly, the time required from the operation end to the stop of the power supply can be shortened.

### Third Embodiment

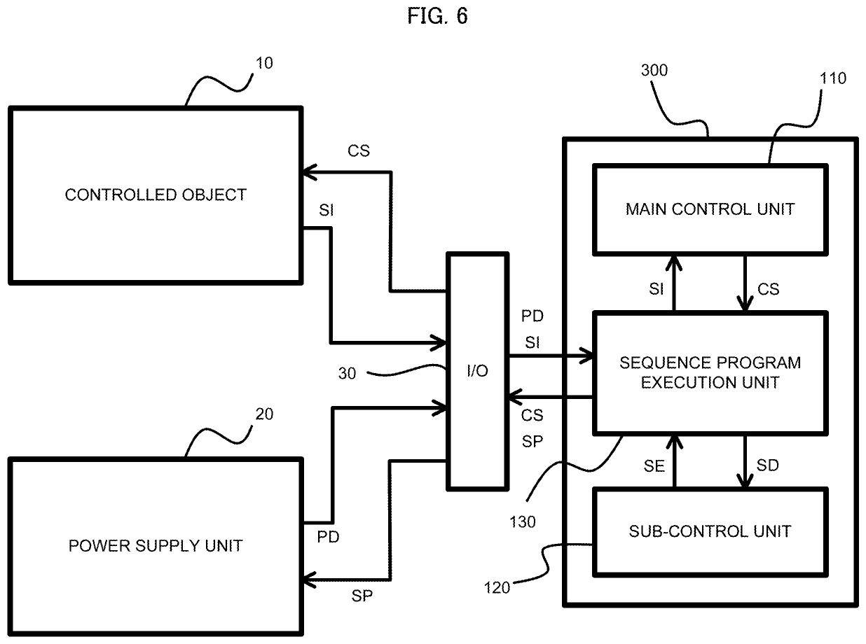

FIG. 6 is a block diagram illustrating a relationship between a control device according to a third embodiment of the present invention and a peripheral device connected to the control device. In addition, also in the third embodiment, components that can adopt the same or common configurations as those of the control device illustrated in FIG. 1 or 4 are denoted by the same reference numerals, and repeated description thereof will be omitted.

A control device 300 according to the third embodiment is configured as an integrated unit of the main control unit 110, a sub-control unit 120, and a sequence program execution unit 130. Here, as one aspect of an “integrated control device 300”, a device in which the main control unit 110, the sub-control unit 120, and the sequence program execution unit 130 are attached on the same substrate, a device in which these are arranged in the same housing, a device in which functions of the same processor are divided into three and used, or the like can be adopted.

As illustrated in FIG. 6, by incorporating the sequence program execution unit 130 into the control device 300 as a unit integrated with the main control unit 110 and the sub-control unit 120, these units can exchange signals with each other inside the unit. Therefore, the entire configuration can be simplified.

With the above configuration provided, the control device and the safe stop program according to the third embodiment of the present invention can simplify the entire configuration of the control device 300 in addition to the effects described in the first and second embodiments, so that the I/O unit 30 can be downsized and an operation load of the sequence program execution unit 130 can also be reduced.

The present invention is not limited to the embodiments above, and can be appropriately changed without departing from the scope of the invention. In the present invention, any component of the embodiment can be modified or any component of the embodiment can be omitted within the scope of the invention.

For example, in the above embodiment, a case where the power stop signal is generated based on the input from the input mechanism provided in the power supply unit has been exemplified. However, for example, a signal from another device such as an input means provided in the controlled object may be used as an alternative signal.

### REFERENCE SIGNS LIST

10 Controlled object
20 Power supply unit
30 I/O unit
100, 200 Control device
110 Main control unit
120 Sub-control unit
130 Sequence program execution unit
300 (Integrated) control device

1. A control device comprising: a main control unit configured to control a main operation of a controlled object; a sub-control unit configured to control an operation of an attached device of the controlled object; and a sequence program execution unit configured to transmit and receive a command to and from the main control unit and the sub-control unit, wherein
the sequence program execution unit has a function of transmitting a stop command signal to the sub-control unit when receiving a power stop signal from outside, and then transmitting a power stop command signal to an external power supply unit when receiving a stop confirmation signal from the sub-control unit.

2. The control device according to claim 1, wherein
the sequence program execution unit further has a function of immediately transmitting the power stop command signal when the stop confirmation signal from the sub-control unit is not received within a predetermined time.

3. The control device according to claim 1, wherein
the sequence program execution unit further has a function of transmitting the stop command signal to the main control unit when receiving the power stop signal from outside, and then transmitting the power stop command signal to the power supply unit when receiving the stop confirmation signal from the main control unit.

4. The control device according to claim 1, wherein
the main control unit, the sub-control unit, and the sequence program execution unit are configured as an integrated unit.

5. A safe stop program for causing a sequence program execution unit of a control device including a main control unit configured to control a main operation of a controlled object, a sub-control unit configured to control an operation of an attached device of the controlled object, and the sequence program execution unit configured to transmit and receive a command to and from the main control unit and the sub-control unit to execute a series of safe stop operations to be described below, wherein a step of receiving a power stop signal from outside;
a step of transmitting a stop command signal to the sub-control unit;
a step of receiving a stop confirmation signal from the sub-control unit; and
a step of transmitting a power stop command signal to an external power supply unit
are caused to execute.

6. The safe stop program according to claim 5, wherein
a step of immediately transmitting the power stop command signal when the stop confirmation signal from the sub-control unit is not received within a predetermined time is further caused to execute.

7. The safe stop program according to claim 5 further execute, wherein
a step of transmitting the stop command signal to the main control unit after receiving the power stop signal from outside; and
a step of receiving the stop confirmation signal from the main control unit.

8. A storage medium storing a safe stop program for causing a sequence program execution unit of a control device including a main control unit configured to control a main operation of a controlled object, a sub-control unit configured to control an operation of an attached device of the controlled object, and the sequence program execution unit configured to transmit and receive a command to and from the main control unit and the sub-control unit to execute a series of safe stop operations to be described below, wherein
the safe stop program is caused to execute,
a step of receiving a power stop signal from outside;
a step of transmitting a stop command signal to the sub-control unit;
a step of receiving a stop confirmation signal from the sub-control unit; and
a step of transmitting a power stop command signal to an external power supply unit.

9. The storage medium according to claim 8, wherein
the safe stop program is further caused to execute a step of immediately transmitting the power stop command signal when the stop confirmation signal from the sub-control unit is not received within a predetermined time.

10. The storage medium according to claim 8, wherein
the safe stop program is further caused to execute,
a step of transmitting the stop command signal to the main control unit after receiving the power stop signal from outside; and
a step of receiving the stop confirmation signal from the main control unit.
